(19) United States
(12) Patent Application Publication
(10) Pub. No.: US 2009/0044159 A1
(43) Pub. Date: Feb. 12, 2009

(54) False path handling

(75) Inventors: Gil Vinitzky, Azur (IL); Eran Dagan, Tel Aviv (IL); Ronny Sherer, Raanana (IL)

Correspondence Address: ABELMAN, FRAYNE & SCHWAB, 666 THIRD AVENUE, 10TH FLOOR, NEW YORK, NY, 10017, US

(73) Assignee: MPLICITY LTD.

(21) Appl. No.: 11/890,951

(22) Filed: Aug. 8, 2007

(51) Int. Cl. G06F 17/50

(52) U.S. Cl. 716/6

(57) ABSTRACT

A method for circuit design includes performing a timing analysis of a design of a processing stage in an integrated electronic circuit. The processing stage has inputs and outputs and includes circuit components arranged so as to define multiple logical paths between the inputs and the outputs. A timing constraint to be applied in splitting the processing stage into multiple sub-stages is specified. At least one of the logical paths is identified as a false path, to which the timing constraint is not to apply. The design is modified responsively to the timing analysis, to the timing constraint, and to identification of the false path, so as to split the processing stage into the sub-stages.

### FIELD OF THE INVENTION

The present invention relates generally to integrated circuit design, and specifically to tools and techniques for adding multithreading support to existing digital circuit designs.

### BACKGROUND OF THE INVENTION

Multithreading is commonly used to enhance the performance of modern microprocessors and programming languages. Multithreading may be defined as the logical separation of a processing task into independent threads, which are activated individually and require limited interaction or synchronization between threads. In a pipelined processor, for example, the pipeline stages may be controlled to process two or more threads in alternation and thus use the pipeline resources more efficiently.

U.S. Patent Application Publication US 2003/0046517 A1, whose disclosure is incorporated herein by reference, describes apparatus for facilitating multithreading in a computer processor pipeline. A logic element is inserted into a pipeline stage to separate it into first and second substages. A control mechanism controls the first and second substages so that the first substage can process an operation from a first thread, and the second substage can simultaneously process a second operation from a second thread.

U.S. Patent Application Publication US 2003/0135716 A1, whose disclosure is incorporated herein by reference, describes a method for converting a computer processor configuration having a k-phased pipeline into a virtual multithreaded processor. For this purpose, each pipeline phase of the processor configuration is divided into a plurality of sub-phases, and at least one virtual pipeline with k sub-phases is created within the pipeline. In this manner, a single physical processor can be made to operate as multiple virtual processors, each equivalent to the original processor. Further aspects of this method are described in U.S. Patent Application Publication US 2007/0005942 A1, whose disclosure is likewise incorporated herein by reference.

### SUMMARY OF THE INVENTION

Embodiments of the present invention provide tools and techniques that can be used for creating additional processing stages in an existing circuit design. In some embodiments, these techniques may be used to add multithreading capability to an existing circuit, such as modifying a single-thread design to support two or more parallel threads. In other embodiments, these techniques may be applied, mutatis mutandis, to an existing multithread design in order to increase the number of threads that it will support, or to increase the depth of a pipeline for substantially any other purpose.

In some embodiments of the present invention, as described in detail hereinbelow, one or more circuit components, referred to herein as a “splitters,” are inserted into the design of a processing stage in order to split the stage into sub-stages for multithreading. Timing analysis of the processing stage is used to identify points at which the processing stage may be split and still satisfy the timing constraints of multithreaded operation.

This process may be complicated unnecessarily, however, by the existence of “false paths” in the original design. A “false path” in this context means a logical path through the original design that need not meet the timing constraints that are imposed on the multithreaded circuit. Typically, the path may be identified as false because it is never traversed in actual operation of the circuit. Alternatively, the designer of the circuit may designate the path as “false” on the basis of other considerations relating to optimization of the design. The embodiments described below provide methods for adding multithreading capability to a design while neutralizing the effect of such false paths.

There is therefore provided, in accordance with an embodiment of the present invention, a method for circuit design, including:

performing a timing analysis of a design of a processing stage in an integrated electronic circuit, the processing stage having inputs and outputs and including circuit components arranged so as to define multiple logical paths between the inputs and the outputs;

specifying a timing constraint to be applied in splitting the processing stage into multiple sub-stages;

identifying at least one of the logical paths as a false path, to which the timing constraint is not to apply;

responsively to the timing analysis, to the timing constraint, and to identification of the false path, modifying the design so as to split the processing stage into the sub-stages.

Typically, identifying the at least one of the logical paths includes identifying a logical path that is not traversed during actual operation of the circuit.

In a disclosed embodiment, specifying the timing constraint includes specifying a cycle time of the circuit, wherein modifying the design includes identifying a window within the processing stage containing a set of connection points among the circuit components at which the processing stage can be split, and inserting splitter components at one or more of the connection points in the set.

In some embodiments, modifying the design includes duplicating one or more of the circuit components responsively to the identification of the false path so as to create a replicated physical path through the circuit. Typically, modifying the design includes, after creating the replicated physical path, identifying connection points among the circuit components at which the processing stage can be split, and inserting splitter components at a plurality of the connection points in the set. Identifying the connection points may include repeating the timing analysis after creating the replicated physical path, and determining the connection points at which to insert the splitter components responsively to the repeated timing analysis. Additionally or alternatively, duplicating the one or more of the circuit components includes identifying an initial component having unbalanced inputs, at least one of which is associated with the false path, and duplicating at least the initial component.

In a disclosed embodiment, splitting the processing stage includes adding multithreading capability to the circuit. In another embodiment, the method includes identifying a new false path in the modified design, and outputting an indication of the new false path.

There is also provided, in accordance with an embodiment of the present invention, apparatus for circuit design, including:

an input interface, which is coupled to receive a design of a processing stage in an integrated electronic circuit, the processing stage having inputs and outputs and including circuit components arranged so as to define multiple logical paths between the inputs and the outputs; and

a design processor, which is configured to split the processing stage into multiple sub-stages by modifying the design responsively to a timing analysis of the processing stage, to a specified timing constraint to be applied in splitting the processing stage into multiple sub-stages, and to an identification of at least one of the logical paths as a false path, to which the timing constraint is not to apply.

There is additionally provided, in accordance with an embodiment of the present invention, a computer software product, including a computer-readable medium in which program instructions are stored, which instructions, when read by a computer, cause the computer to receive a design of a processing stage in an integrated electronic circuit, the processing stage having inputs and outputs and including circuit components arranged so as to define multiple logical paths between the inputs and the outputs, and to split the processing stage into multiple sub-stages by modifying the design responsively to a timing analysis of the processing stage, to a specified timing constraint to be applied in splitting the processing stage into multiple sub-stages, and to an identification of at least one of the logical paths as a false path, to which the timing constraint is not to apply.

The present invention will be more fully understood from the following detailed description of the embodiments thereof, taken together with the drawings in which:

### BRIEF DESCRIPTION OF THE DRAWINGS

FIG. 1 is a schematic, pictorial illustration of a system for integrated circuit design, in accordance with an embodiment of the present invention;

FIG. 2 is a block diagram that schematically illustrates a processor design in which a processing stage is split into sub-stages, in accordance with an embodiment of the present invention;

FIG. 3 is a block diagram that schematically illustrates a processing stage, showing timing considerations with regard to splitting the stage into sub-stages for multithreading, in accordance with an embodiment of the present invention;

FIGS. 4-6 are block diagrams that schematically illustrate successive stages in a process of modifying a processing stage for multithreaded operation, in accordance with an embodiment of the present invention;

FIG. 7 is a block diagram that schematically illustrates timing constraints in a processing stage that is to be modified for multithreaded operation, in accordance with an embodiment of the present invention;

FIG. 8 is a flow chart that schematically illustrates a method for modifying a design of a circuit to add multithreading capability to the circuit, in accordance with an embodiment of the present invention; and

FIG. 9 is a block diagram that schematically illustrates a modification of the design of the processing stage of FIG. 7 in preparation for adding multithreading capability to the processing stage, in accordance with an embodiment of the present invention.

### DETAILED DESCRIPTION OF EMBODIMENTS

FIG. 1 is a schematic pictorial illustration of a system 20 for integrated circuit design, in accordance with an embodiment of the present invention. The system processes an input design 22 in order to generate an output design 24 with similar functionality and added multithreading capability. System 20 comprises a design processor 26, having an input interface 28 for receiving the input design and an output interface 30 for delivering the multithreaded output design. The input design may be provided in a suitable design language, such as register transfer language (RTL), or it may have already been synthesized in the form of a gate level netlist. The output design may be generated in similar form.

Processor 26 typically comprises a general-purpose computer, which is programmed in software to perform the functions that are described herein. This software may be downloaded to processor 26 in electronic form, over a network, for example, or it may alternatively be furnished on tangible media, such as optical, magnetic or electronic memory media. The software may be supplied as a stand-alone package, or it may alternatively be integrated with other electronic design automation (EDA) software. Thus, input interface 28 and output interface 30 of the processor may comprise communication interfaces for exchanging electronic design files with other computers or storage components, or they may alternative comprise internal interfaces within a multi-function EDA system.

In the examples that follow, input design 22 is assumed, for the sake of simplicity and clarity, to be a single-thread (ST) design, while the output multithread (MT) design 24 is assumed to support dual threads. The principles of the present invention may be applied, however, in generating output designs that support three or more simultaneous threads, starting from input designs that may be either single-thread or multithreaded. Further details regarding techniques for adding multithreading capability to existing designs are described in the above-mentioned U.S. Patent Application Publications US 2003/0135716 A1 and US 2007/0005942 A1, as well as in PCT International Publication WO 2006/092792, whose disclosure is incorporated herein by reference.

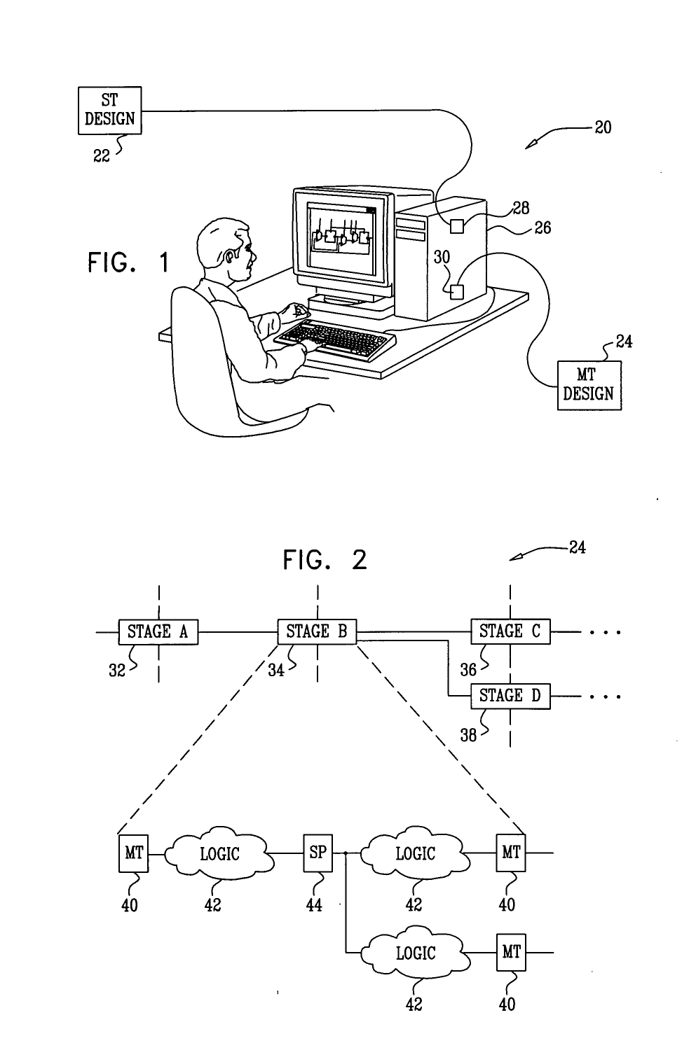

FIG. 2 is a block diagram that schematically illustrates output design 24 following adaptation of the design for dual-threaded processing, in accordance with an embodiment of the present invention. Input design 22 is assumed to comprise processing stages 32, 34, 36, 38, each of which is divided into two successive sub-stages in output design 24. This process is illustrated specifically with respect to stage 34: Multithreading (MT) cells 40 are typically inserted between stages in order to store the machine states of the alternating threads that are processed successively by each stage. Static timing analysis is applied to logic 42 of stage 34 in order to determine where to insert a splitter (SP) 44 in between the logic components. The splitter may comprise any suitable separator between the preceding and succeeding phases, such as a D-flipflop for each bit that is to be transferred.

As a result of splitting stage 34, the portion of the stage to the left of splitter 44 can execute an instruction in one thread, while the portion to the right of the splitter executes an instruction in another thread. The location of the splitter is determined, as described in detail hereinbelow, so that the logical blocks on both sides of the splitter execute within one cycle of the device clock. As a result, the single-thread input design 22 is converted to a dual-thread design. Processor 26 applies a novel circuit analysis technique, as described in detail hereinbelow, in order to determine where and how to place the splitters so to achieve optimal timing performance, depending on the actual operation of logical paths in the circuit.

The principles illustrated by FIG. 2 and the techniques described below for implementing these principles may be used not only for dual-threaded processing, but also in circuits for N-threaded processing, with N>2. Furthermore, by appropriate arrangement of the input/output (I/O) busses to a multithread processing circuit that is created in accordance with these principles, the circuit can be made to emulate a multi-core device (with a separate I/O bus for each of the “virtual cores”). References to multithread designs and processing capability in the present patent application and in the claims should therefore be understood to include this sort of multi-core emulation.

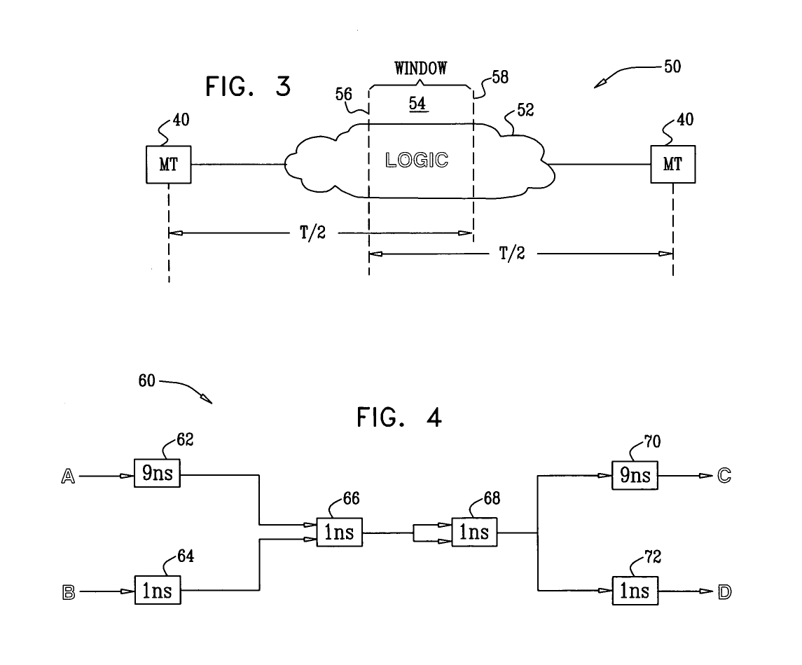

FIG. 3 is a block diagram that schematically illustrates a processing stage 50, showing timing considerations with regard to splitting the stage into substages for multithreading, in accordance with an embodiment of the present invention. Stage 50 comprises logic circuits 52, bounded by MT cells 40. It is assumed in this example that each stage of the original single-thread design is expected to execute within a clock cycle of duration T. Thus, in dual-threaded operation, each sub-stage should execute within half a clock cycle, T/2.

As noted above, system 20 (FIG. 1) performs a static timing analysis in order to determine where to place splitters 44 in stage 50. This timing analysis defines a window 54 in which splitters may be placed. The size of the window is determined by the requirement that each of the sub-stages defined by the splitters must be capable of execution within T/2. Thus, the window has a leading boundary 56 at points having an output path length (i.e., the time needed for execution of the remaining logic components between these points and the end of stage 50) equal to T/2. The window has a trailing boundary 58 at points having an input path length (time for execution from the beginning of stage 50 to the points) of T/2. In other words, all the points in the window have input and output path lengths no greater than T/2. In the description that follows, the input and output paths lengths are also referred to, respectively, as the “forward delay” and “reverse delay.”

In general, the splitters may be placed anywhere within window 54, as long as timing constraints among parallel components in the window are observed, and each of the resulting sub-stages will complete execution within T/2. When a number of different splitter locations are possible, it is advantageous to place the splitters in such as way as to minimize the number of separate splitters that must be used and/or to minimize the total execution time of the entire stage. On the other hand, under some circumstances it may be necessary or desirable to relax the timing constraints, i.e., to expand boundaries 56 and/or 58 of window 54 beyond the initial T/2 limits described above. Furthermore, imbalances in the timing of different logical paths through stage 50 may mandate duplication of certain circuit components in the stage in order to facilitate optimal splitter placement. A method for optimizing splitter placement under these conditions is described hereinbelow with reference to the figures that follow.

Further methods for placing splitters in a circuit and other aspects of techniques for adding multithreading capability to a circuit design are described in U.S. patent application Ser. No. 11/599,933, filed Nov. 15, 2006, which is assigned to the assignee of the present patent application, and whose disclosure is incorporated herein by reference.

FIG. 4 is a block diagram that schematically illustrates a processing stage 60 that is to be modified for multithreaded operation in accordance with an embodiment of the present invention. Stage 60 has inputs A and B and outputs C and D. Logical paths through stage 60 connect the inputs to the outputs via circuit components 62, 64, 66, 68, 70 and 72. These circuit components are functional design components, which may comprise one or more actual electrical components. A timing analysis of the circuit components is applied to determine the respective execution times of the components, which are marked on the components in the figure (in nanoseconds).

The path length of any given path through stage 60 is given by the sum of the execution times of the components along that path. Timing analysis of stage 60 reveals the following paths and respective path lengths between the inputs and outputs of the circuit:
A-C: 20 ns.
A-D: 12 ns.
B-C: 12 ns.
B-D: 4 ns.

Superficial analysis of the circuit would appear to indicate that the optimal place for a splitter in stage 60 will be between components 66 and 68. In this case, each half of each logical path A-C will execute in 10 ns, and the execution time T of stage 60 will be 20 ns.

The considerations will be different, however, if it is specified that the desired execution time T=12 ns, and path A-C is a false path. Typically, these considerations are specified by the operator of system 20, based on design and performance constraints. Alternatively or additionally, such considerations may be inferred automatically by processor 26. Path A-D may be considered a false path, for example, on the basis of static or dynamic logic analysis showing that this path is never actually traversed during execution of the processor to which stage 60 belongs. Alternatively or additionally, path A-C may be labeled as a “false path” because it is not subject to the critical execution time constraint and is thus permitted to take multiple cycles for execution.

Given these new constraints (T=12 ns and A-C a false path), the placement of a splitter between components 66 and 68 is incorrect: This placement will cause the first portion of path A-D to execute to execute in 10 ns, and likewise the second portion of path B-C. Rather, to meet the execution time constraint, it is necessary to insert splitters inside components 62 and 70. Now each of paths A-D and B-C can execute in two successive half-cycles of 6 ns each. A splitter is also needed in path B-D, in order to maintain balanced timing, with execution in two half-cycles, between all of the “real paths” through stage 60. (All real paths must contain exactly one splitter for this reason). The topology of stage 60, however, does not provide any point at which path B-D can be split while still permitting the other real paths to execute within the 6 ns time constraint. In order to overcome this problem, processor 26 identifies the unbalanced paths and replicates certain circuit components in order to enable balanced splitting of all real paths, as described hereinbelow.

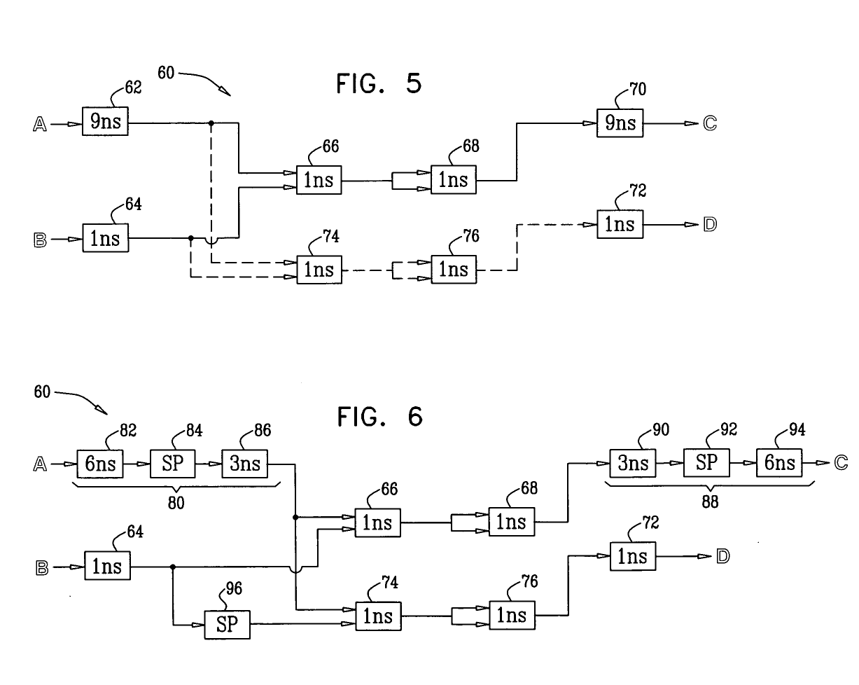

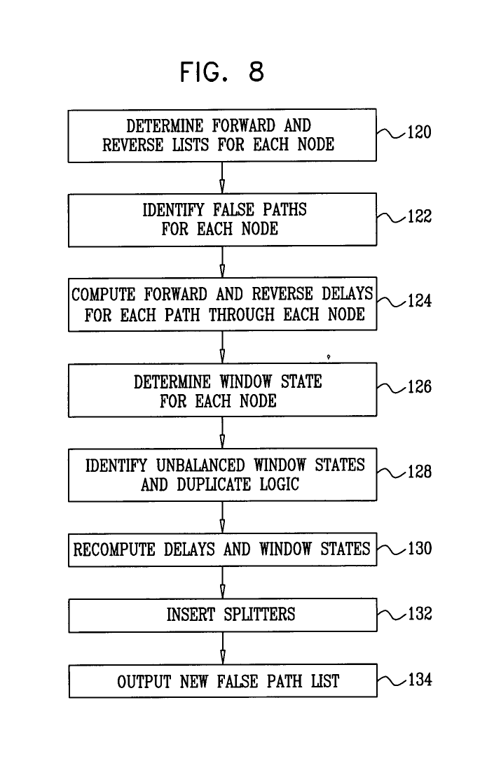

FIG. 5 is a block diagram that schematically illustrates a modification to processing stage 60 for eliminating unbalanced paths, in accordance with an embodiment of the present invention. In this example, components 66 and 68 are replicated by adding respective, identical components 74 and 76 to stage 60. The purpose of the modification is to physically separate the “unbalanced” portion of path B-D from paths A-D and B-C, so that path B-D may be split independently of paths A-D and B-C. The separate physical paths that are now created from A to D and from B to D are shown as dashed lines for the sake of clarity. The task of modifying stage 60 is simplified by the knowledge that path A-C is a false path and therefore need not be balanced in this manner. A systematic method for automatically identifying and separating unbalanced paths, using knowledge of false paths, is described hereinbelow with reference to FIG. 8.

FIG. 6 is a block diagram that schematically illustrates splitting of stage 60 for multithreaded execution, following the modification of FIG. 5, in accordance with an embodiment of the present invention. Component 62 is now replaced by an equivalent split component 80, comprising sub-components 82 and 86, separated by a splitter (SP) 84. Sub-components 82 and 86, with respective execution times of 6 ns and 3 ns, together perform the same function as component 62. Similarly, component 70 is replaced by an equivalent split components 88, comprising sub-components 90 and 94, separated by a splitter 92. For balanced operation, a splitter 96 is inserted between components 64 and 74 in path B-D. Now, all of the real paths in stage 60 will execute in two half-cycles that are no longer than T/2=6 ns, so that the multithreaded stage 60 meets the execution time constraint T=12 ns.

After the modifications shown in FIGS. 5 and 6 are completed, processor 26 typically checks again to ascertain that stage 60 is balanced (i.e., all paths execute in the same number of half-cycles) and meets the applicable timing constraints. For this purpose, each of the splitters is identified as an input and output node for the partial paths that respectively originate from and terminate at the splitter. The processor now applies the original definition of A-C as a false path to the sub-path between splitters 84 and 92 along path A-C. The redesign of stage 60 may thus be completed and verified.

Although the embodiments described herein relate to the use of false path definitions in resolving unbalanced paths, not all false path definitions necessarily influence the topology of the redesigned circuit in the manner described above, and imbalance may occur in the absence of false paths, as well. As an example of the former case, a false path through a processing stage may inherently have a shorter execution time than the critical real path. In such a case, there will be no need to consider the false path in splitter placement or possible replication of components. In the latter case, it may be necessary to replicate components in order to meet timing constraints even if all the paths through processing stage in question are real paths.

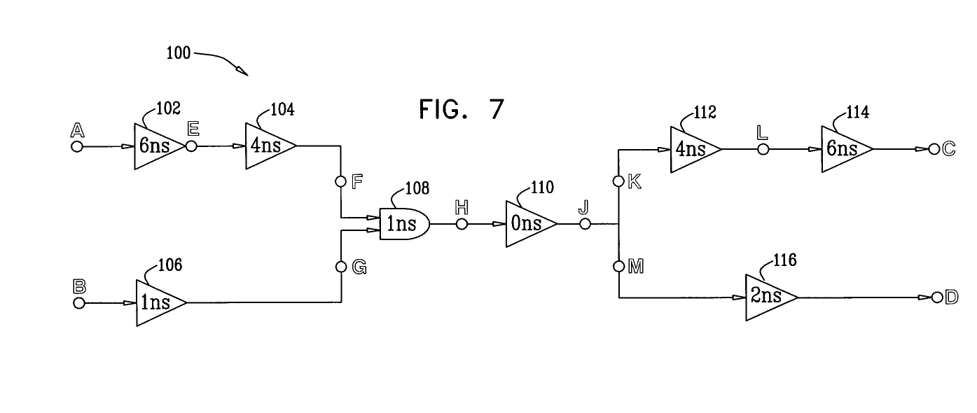

Reference is now made to FIGS. 7 and 8, which schematically illustrate a method for modifying a design of a circuit 100 to add multithreading capability to the circuit, in accordance with an embodiment of the present invention. FIG. 8 is a flow chart that shows key steps in the method. FIG. 7 is a block diagram showing details of circuit 100, presented by way of example as an aid to understanding the method of FIG. 8. The circuit comprises components 102, 104, 106, 108, 110, 112, 114 and 116, marked with respective execution times as in the preceding example. The circuit topography comprises nodes that include inputs A and B, outputs C and D, and intermediate nodes E through M at connection points between the components. It is assumed again in this example that path A-C is a false path.

Processor 26 analyzes the topology of circuit 100 to derive a “forward list” and a “reverse list” for each node, at a list construction step 120. Once the lists have been constructed for each node, they identify the false paths on which the node is located. To construct the forward list, processor 26 goes over the nodes in a topologically-sorted traverse from input to output. The forward list for any input node that is on a false path contains the identification of that input node. The forward path for each subsequent node in the traverse contains the identification of the node or nodes in the forward lists of the nodes preceding the subsequent node on all paths passing through the subsequent node. For output nodes that are endpoints of false paths, the forward list also contains the identification of the output node itself. The reverse list is constructed in the same manner, except that the traverse starts from the output nodes and proceeds to the input nodes. Construction of the forward and reverse lists for circuit 100 gives the following result:

TABLE I
FORWARD AND REVERSE LISTS

| Node | Forward list | Reverse list |
|---|---|---|
| A | A | C, A |
| B | | C |
| E | A | C |
| F | A | C |
| G | | C |
| H | A | C |
| J | A | C |
| K | A | C |
| L | A | C |
| M | A | |
| C | A, C | C |
| D | A | |

Processor 26 takes the union of the forward and reverse lists for each node in order to identify the false paths that pass through each node, at a false path identification step 122. If the union of the lists for a given node includes both of the endpoints of a given false path, then that node is known to be on the false path. Taking the union of the forward and reverse lists in Table I, for example, shows that the false path A-C passes through nodes A, E, F, H, J, K, L and C. No false paths pass through the remaining nodes.

For the purpose of subsequent computation, the processor sets up a node table for each node, to hold information regarding the forward and reverse delays of the node and whether the node falls inside the window in which splitters may be placed, as explained above in reference to FIG. 3. The node table for each node contains one row for each false path having an endpoint (input or output) on the forward and/or reverse list for that node, plus a row for all other paths (the “real paths”), as shown in the following table:

TABLE II
NODE TABLE FORMAT

| | Forward delay | Reverse delay | Window state |
|---|---|---|---|
| All other | | | |
| paths | | | |
| Path ending | | | |
| on false path | | | |
| endpoint 1 | | | |
| Path ending | | | |
| on false path | | | |
| endpoint 2 | | | |
| . . . | | | |

The processor computes the forward and reverse delays for each row of the node table at each node, at a delay computation step 124. The forward delay is computed in a topologically-sorted traverse over the nodes, again starting from the input nodes. For each false path starting from a given input node, the processor enters a null value (“X” in the examples that follow) in the forward delay column of the row corresponding to the false path in the node table of each of the relevant nodes. For the real paths, the forward delay value of the input nodes is zero. For each row in the node table of each subsequent node, the processor computes the forward delay by taking the maximum value of the forward delays listed in the corresponding row of the node tables of the nodes directly preceding it, and incrementing this maximum value by the delay incurred between the preceding node and the current node. (Of course, if there is only a single node directly preceding the current node, then the “maximum value” is the forward delay listed in the corresponding row of the single node.) On the other hand, if the forward delay column in a given row of the node tables of all the directly-preceding nodes contains a null value, then the processor will enter the null value as the forward delay value of the current node, as well.

Table III below shows the forward delay values that are computed in this matter for the nodes in circuit 100 that are shown in FIG. 7:

TABLE III
FORWARD DELAY VALUES

| | Node: | | | | | | | | | | | |
|---|---|---|---|---|---|---|---|---|---|---|---|---|
| | A | B | E | F | G | H | J | K | L | M | C | D |
| Real paths | 0 | 0 | 6 | 10 | 1 | 11 | 11 | | | 11 | | 13 |
| Paths ending | X | 0 | X | X | 1 | 2 | 2 | 2 | 8 | | 12 | |
| on node C | | | | | | | | | | | | |
| (including false | | | | | | | | | | | | |
| path A-C) | | | | | | | | | | | | |

The reverse delay values are computed in the same fashion, in a topologically-sorted traverse starting at the output nodes and progressing back to the input nodes.

Processor 26 applies the calculated forward and reverse delay values to determine the window states for each node, at a window determination step 126. For each node, the window state is computed for each row of the node table. In other words, if both the forward and reverse delay values in a given row are less than the predetermined threshold (T/2 in the example shown above in FIG. 3), then the window state for that row is set to “in”, indicating that the node is inside the window. If one of the delay values is greater than the threshold, the window state is set to “L” or “R”, indicating respectively that the node is to the left of the window (i.e., reverse delay greater than the threshold) or to the right of the window (forward delay greater than the threshold). If the forward or reverse delay has a null value (“X”), then the window state is also set to a null value.

Typically, the threshold for determining window states is initially set to half the delay of the longest real path in the circuit. In the example shown in FIG. 7, the longest real path is AD, with delay of 13 ns, as shown above in Table III. If the threshold is set to ½*13 ns=6.5 ns, however, it will require a splitter to be placed inside component 104. In many cases, the components of a circuit being processed according to the method of FIG. 8 are treated as integral units, which cannot be split internally. Therefore, processor 26 is programmed with heuristic rules for dealing with situations of this sort.

For example, in the present case, the applicable rule may state that for a given component, if the window state in a given row of the node table at the input to the component is “L”, and the window state in that row of the node table at the output from the component is “R”, then the window state at the output is changed to “in”. Therefore, in the present case, the window state in the first row of the node table of node F will be set to “in”. Application of this rule will, in the present case (and in many other cases), have a negative impact on the achievable timing performance of the resulting multithreaded circuit, but this performance may be sufficient for the purposes of the device specification. Alternatively, other rules and policies may be applied in order to resolve the situation of component 104, as well as other situations that may arise involving anomalous window states.

Table IV shows the window states that are determined in this manner for the rows of the node tables for some of the nodes in circuit 100:

TABLE IV
WINDOW STATES

| | Node: | | | | | | |
|---|---|---|---|---|---|---|---|
| | A | B | E | F | G | H | . . . |
| Real paths | L | in | L | in | in | R | . . . |
| Paths ending on node C | X | L | X | X | L | L | . . . |
| (including false path A-C) | | | | | | | |
| Node window state | out | out | out | in | out | . . . | |

As shown in the last row of the table above, processor 26 determines an overall window state for each node based on the row window states. If a given node has a row in its node table that is out of window (i.e., marked “L” or “R”), then the node itself is marked as being out of window. Otherwise, the node is marked as being in window. (Null window state row entries are disregarded).

Processor 26 applies the window state information in identifying unbalanced instances in circuit 100, at an imbalance identification step 128. An unbalanced instance in this context is a component that has multiple inputs with at least one input in the “L” node window state and another input in the “in” or “R” window state. For example, if the node window state at one of the inputs is in window, while that at another input is out of window, or if the node window states at one of the inputs is “L” while another is “R”, then the component is identified as an unbalanced instance. The processor searches for unbalanced instances in a topologically-sorted traverse starting from the input nodes. In circuit 100, the processor will thus determine that component 108 is an unbalanced instance, since node F, at one input to component 108, is in window, while node G, at the other input, is left of the window.

In order to resolve this imbalance, the processor duplicates the unbalanced instance, and goes on to duplicate the succeeding components until it reaches a component with a multiple output, i.e., a component that has an output connecting to (at least) two subsequent components, at which the imbalance is resolved. Following the duplication, the component with the multiple output is replaced by multiple components, each connecting to one of the subsequent components.

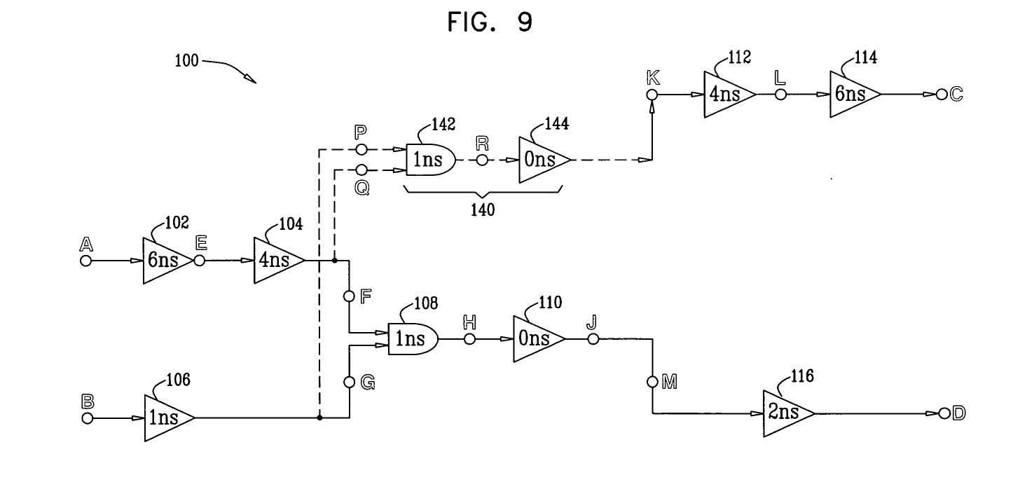

FIG. 9 is a block diagram that schematically illustrates circuit 100 following this sort of duplication of components, in accordance with an embodiment of the present invention. In this case, component 108 (the unbalanced instance) and component 110 have been duplicated, thus creating a replicated physical path 140 comprising components 142 and 144. Each of components 110 and 144 now connects to a single subsequent component, as shown in the figure. The imbalance is resolved following components 110 and 144, so that no further duplication is required.

To determine where the imbalance ends at step 128 (FIG. 8), the row in the node table that caused the window state of the in-window node at the input to the unbalanced instance to be in window is marked as the “causing row”; and the row in the node table that caused the window state of the out-of-window node at the input to the unbalanced instance to be out of window is marked as the “worked row.” Thus, in the present example, as shown above in Table IV, the causing row is the upper row of the node table, while the worked row is the lower row. The processor proceeds forward in a topologically-sorted traverse of the original design (FIG. 7) from the unbalanced instance (component 108) through the subsequent components until it reaches a node with a multiple output (component 110). It then checks the input nodes of the components that are connected to the multiple output (components 112 and 116). If in the node table of one of these input nodes, either the row window state of the “causing row” is null, or the “worked row” is absent (meaning that there is no path corresponding to the “worked row” that passes through the node), the processor determines that the imbalance is resolved at this node. In circuit 100, the lower row is absent from the node table at node M, since it is not located on any path leading to output node C, and the processor thus concludes that the imbalance has been resolved after duplicating component 110 as shown in FIG. 9.

Returning to FIG. 8, following duplication of the components as necessary, processor 26 recomputes the delays and window states at the nodes of the circuit, at a recomputation step 130. The computation is simplified since there are now no false paths through components 108, 110 and 116. On the paths passing through these components, both of nodes F and G are now in window. On the path passing through duplicated components 142 and 144 (ignoring the effect of false path AC), nodes P, Q, R and K remain out of window, in view of the combined reverse delays of components 112 and 114. Node L is thus the first in-window node on this path.

Processor 26 inserts splitters in the redesigned circuit, at a splitter insertion step 132. The splitters are placed at the first in-window nodes on each of the paths, based on the analysis performed at step 130. Thus in the example shown in FIG. 9, splitters will be placed at nodes F, G and L.

Optionally, after inserting splitters in the appropriate locations, processor 26 may generate a new list of false paths for output to other tools in the EDA suite, at a false path output step 134. For example, tools that perform incremental circuit synthesis or place-and-route functions may use false path information in determining where design timing constraints (such as the length limit on a given conductor) may be relaxed. To determine what false paths remain in the circuit, processor 26 applies the sort of procedures that were described above at steps 120 and 122 to the following types of paths in the redesigned circuit:
1. Any path that does not start with a splitter but ends with a splitter.
2. Any path from splitter to splitter.
3. Any path that starts from a splitter but ends with a component other than a splitter.
4. Any false path in the original design that was not changed at step 132.

Every new false path that is found in this manner will contain at least part of an original false path. Paths of type 1 are considered to be false paths if (1) all paths following the splitter in question are false paths, and (2) the path up to the splitter is fully contained in one of the original false paths. Paths of type 3 are considered to be false paths if (1) all paths to the splitter in question are false paths, and (2) the path following the splitter is fully contained in one of the original false paths. A path from a splitter to splitter (type 2) that was part of an original false path will be always defined as a new false path.

Application of the above rules to the redesigned version of stage 60 that is shown in FIG. 6 gives the following results:
From input A to splitter 84 there is no new false path since a real path exists from splitter 84 to output D.
Similarly, from splitter 92 to output C there is no new false path since a real path exists from input B to splitter 92.
From input B to splitter 96 and from splitter 96 to output D there are no new false paths since these new paths are not part of any original false path.
Between splitters 84 and 92 there is a new false path.
   Processor 26 will therefore output the identification of the path between splitters 84 and 92 as a false path at step 134.

The rules and procedure defined above for use at step 134 are defined for cases in which the paths through the circuit in question are split once (as in deepening a pipeline by a single level). These rules and procedures may be adapted in a straightforward manner for application to higher levels of splitting and pipeline deepening.

Although the embodiments described above relate to certain specific simplified circuits and topologies, the principles of these embodiments may similarly be applied to other types of circuits and topologies that contain multiple logical paths. It will thus be appreciated that the embodiments described above are cited by way of example, and that the present invention is not limited to what has been particularly shown and described hereinabove. Rather, the scope of the present invention includes both combinations and subcombinations of the various features described hereinabove, as well as variations and modifications thereof which would occur to persons skilled in the art upon reading the foregoing description and which are not disclosed in the prior art.

1. A method for circuit design, comprising:
performing a timing analysis of a design of a processing stage in an integrated electronic circuit, the processing stage having inputs and outputs and comprising circuit components arranged so as to define multiple logical paths between the inputs and the outputs;
specifying a timing constraint to be applied in splitting the processing stage into multiple sub-stages;
identifying at least one of the logical paths as a false path, to which the timing constraint is not to apply;
responsively to the timing analysis, to the timing constraint, and to identification of the false path, modifying the design so as to split the processing stage into the sub-stages.

2. The method according to claim 1, wherein identifying the at least one of the logical paths comprises identifying a logical path that is not traversed during actual operation of the circuit.

3. The method according to claim 1, wherein specifying the timing constraint comprises specifying a cycle time of the circuit.

4. The method according to claim 3, wherein modifying the design comprises identifying a window within the processing stage containing a set of connection points among the circuit components at which the processing stage can be split, and inserting splitter components at one or more of the connection points in the set.

5. The method according to claim 1, wherein modifying the design comprises duplicating one or more of the circuit components responsively to the identification of the false path so as to create a replicated physical path through the circuit.

6. The method according to claim 5, wherein modifying the design comprises, after creating the replicated physical path, identifying connection points among the circuit components at which the processing stage can be split, and inserting splitter components at a plurality of the connection points in the set.

7. The method according to claim 6, wherein identifying the connection points comprises repeating the timing analysis after creating the replicated physical path, and determining the connection points at which to insert the splitter components responsively to the repeated timing analysis.

8. The method according to claim 5, wherein duplicating the one or more of the circuit components comprises identifying an initial component having unbalanced inputs, at least one of which is associated with the false path, and duplicating at least the initial component.

9. The method according to claim 1, wherein splitting the processing stage comprises adding multithreading capability to the circuit.

10. The method according to claim 1, and comprising identifying a new false path in the modified design, and outputting an indication of the new false path.

11. Apparatus for circuit design, comprising:
an input interface, which is coupled to receive a design of a processing stage in an integrated electronic circuit, the processing stage having inputs and outputs and comprising circuit components arranged so as to define multiple logical paths between the inputs and the outputs; and
a design processor, which is configured to split the processing stage into multiple sub-stages by modifying the design responsively to a timing analysis of the processing stage, to a specified timing constraint to be applied in splitting the processing stage into multiple sub-stages, and to an identification of at least one of the logical paths as a false path, to which the timing constraint is not to apply.

12. The apparatus according to claim 11, wherein the false path comprises a logical path that is not traversed during actual operation of the circuit.

13. The apparatus according to claim 11, wherein the timing constraint comprises a specified cycle time of the circuit.

14. The apparatus according to claim 13, wherein the processor is configured to identify a window within the processing stage containing a set of connection points among the circuit components at which the processing stage can be split, and to insert splitter components at one or more of the connection points in the set.

15. The apparatus according to claim 11, wherein the processor is configured to duplicate one or more of the circuit components responsively to the identification of the false path so as to create a replicated physical path through the circuit.

16. The apparatus according to claim 15, wherein the processor is configured to identify connection points among the circuit components at which the processing stage can be split, and to insert splitter components at a plurality of the connection points in the set, after creating the replicated physical path.

17. The apparatus according to claim 16, wherein the processor is configured to repeat the timing analysis after creating the replicated physical path, and to determine the connection points at which to insert the splitter components responsively to the repeated timing analysis.

18. The apparatus according to claim 15, wherein the processor is configured to create the replicated physical path by identifying an initial component having unbalanced inputs, at least one of which is associated with the false path, and duplicating at least the initial component.

19. The apparatus according to claim 11, wherein the design processor is configured to split the processing stage so as to add multithreading capability to the circuit.

20. The apparatus according to claim 11, wherein the design processor is configured to identify a new false path in the modified design, and to output an identification of the new false path.

21. A computer software product, comprising a computer-readable medium in which program instructions are stored, which instructions, when read by a computer, cause the computer to receive a design of a processing stage in an integrated electronic circuit, the processing stage having inputs and outputs and comprising circuit components arranged so as to define multiple logical paths between the inputs and the outputs, and to split the processing stage into multiple sub-stages by modifying the design responsively to a timing analysis of the processing stage, to a specified timing constraint to be applied in splitting the processing stage into multiple sub-stages, and to an identification of at least one of the logical paths as a false path, to which the timing constraint is not to apply.

22. The product according to claim 21, wherein the false path comprises a logical path that is not traversed during actual operation of the circuit.

23. The product according to claim 21, wherein the timing constraint comprises a specified cycle time of the circuit.

24. The product according to claim 23, wherein the instructions cause the computer to identify a window within the processing stage containing a set of connection points among the circuit components at which the processing stage can be split, and to insert splitter components at one or more of the connection points in the set.

25. The product according to claim 21, wherein the instructions cause the computer to duplicate one or more of the circuit components responsively to the identification of the false path so as to create a replicated physical path through the circuit.

26. The product according to claim 25, wherein the instructions cause the computer to identify connection points among the circuit components at which the processing stage can be split, and to insert splitter components at a plurality of the connection points in the set, after creating the replicated physical path.

27. The product according to claim 26, wherein the instructions cause the computer to repeat the timing analysis after creating the replicated physical path, and to determine the connection points at which to insert the splitter components responsively to the repeated timing analysis.

28. The product according to claim 25, wherein the instructions cause the computer to create the replicated physical path by identifying an initial component having unbalanced inputs, at least one of which is associated with the false path, and duplicating at least the initial component.

29. The product according to claim 21, wherein the instructions cause the computer to split the processing stage so as to add multithreading capability to the circuit.

30. The product according to claim 21, wherein the instructions cause the computer to identify a new false path in the modified design, and to output an identification of the new false path.
